(19) United States
(12) Patent Application Publication
(10) Pub. No.: US 2007/0053058 A1
(43) Pub. Date: Mar. 8, 2007

(54) Lighting assembly for a luminescence analysis apparatus, in particular a fluorescence mrcroscope, and luminescence analysis apparatus equipped with such a lighting assembly

(76) Inventors: Marco Angelini, Bereguardo (IT); Natale Baraldo, Paderno Dugnano (IT); Claudia Bigliati, Trino (IT); Luca Scodes, Sant'Angelo Lodigiano (IT)

Correspondence Address: LADAS & PARRY, 26 WEST 61ST STREET, NEW YORK, NY, 10023, US

(21) Appl. No.: 10/552,265

(22) PCT Filed: Mar. 31, 2004
(86) PCT No.: PCT/IB04/00976

§ 371 Date: Aug. 11, 2006

(30) Foreign Application Priority Data
Apr. 2, 2003 (IT) MI2003A000650

(51) Int. Cl. G02B 21/06

(52) U.S. Cl. 359/386

(57) ABSTRACT

A luminescence analysis apparatus, in particular for fluorescence microscopy, has a lighting assembly having a lighting unit which includes a preassembled module housed inside a housing; the module is defined by a LED mounted on a plate, and by an optical collimating element connected integrally to the LED and located in close proximity to the LED; the optical element is a catadioptric collimator made of transparent plastic material and designed to internally convey and transmit the light emitted by the LED, so as to generate a substantially parallel beam of light rays which is directed onto a luminesce sample for analysis.

### TECHNICAL FIELD

The present invention relates to a lighting assembly for a luminescence analysis apparatus, in particular a fluorescence microscope, and to a luminescence analysis apparatus, in particular for fluorescence microscopy, comprising such a lighting assembly.

### BACKGROUND ART

As is known, in fluorescence microscopy, the sample contains a fluorescent substance (contained naturally in or introduced into the sample) which, when struck and excited by a light beam in a given spectral band, itself fluoresces in a different (higher-wavelength) spectral band. Emission by the sample is then collected by a special device and observed directly in an eyepiece.

As fluorescence analysis normally calls for intense illumination of the sample, concentrated in a small area, known fluorescence microscopes employ high-efficiency light sources, typically short-arc discharge or halogen lamps or laser sources.

Microscopes equipped with light sources of this type, however, have various drawbacks. In particular, conventional discharge or halogen lamps are relatively expensive, consume a large amount of energy, and are of short life. Moreover, lamps of this sort emit in wide bands, normally also extending to ultraviolet and/or infrared, so that, besides heating and possibly deteriorating samples by radiation, heavy filters are required, in that only a small emission band (capable of exciting the fluorescent substance) must reach the sample. In any case, the percentage of effective light (i.e. reaching the sample) is very small (less than 10%). Moreover, discharge and halogen lamps call for complex electronics for controlling turn-on and discharge, and relatively complex, i.e. high-cost, optical systems for concentrating emission on the small area of interest. Finally, lamps of this sort, and therefore the microscope as a whole, are normally fairly bulky, so that portable, or at least small-size, apparatuses are impossible to achieve. This problem is further compounded by the high energy consumption of the lamps, which cannot be battery-powered.

Fluorescence microscopes equipped with laser sources also have some of these drawbacks, on account of laser sources in particular being fairly complex, expensive and bulky.

Similar drawbacks are also found in other types of fluorescence and luminescence analysis equipment in general, as used for example in spectrophotometry, fluorometry, etc.

In other words, compact (portable), low-cost, low-power fluorescence microscopes or luminescence analysis equipment in general are not currently available.

### DISCLOSURE OF INVENTION

It is an object of the present invention to provide a luminescence analysis apparatus, in particular a fluorescence microscope, designed to eliminate the aforementioned drawbacks of the known art.

In particular, it is an object of the invention to solve the aforementioned problems by providing a lighting assembly for a luminescence analysis apparatus, in particular a fluorescence microscope.

In particular, it is an object of the invention to provide a fluorescence microscope, and a luminescence analysis apparatus in general, which is compact (at least portable), and which is cheap and easy to produce and use.

According to the present invention, there is provided a lighting assembly for a luminescence analysis apparatus, in particular a fluorescence microscope, as defined in the accompanying claim 1.

The invention also relates to a luminescence analysis apparatus, in particular for fluorescence microscopy, comprising such a lighting assembly.

The apparatus equipped with the lighting assembly according to the invention eliminates the aforementioned drawbacks of the known art by being, in particular, highly compact and cheap to produce. Moreover, LEDs consume much less energy, are more efficient, and have a much longer life (typically over 50000 hours, as compared with the 100-1000 hours of conventional lamps) than sources normally used in luminescence analysis equipment.

Moreover, LEDs emit in narrow bands and can be selected to meet specific requirements, so that simpler, cheaper, or high-quality filters can be used (the signal/noise ratio, in fact, is higher than in lamp systems, in that LEDs, unlike lamps, have very low off-band emissions which can therefore be filtered effectively). In any case, the percentage of light actually directed onto the sample is much higher than in known solutions, and there is no problem of overheating the apparatus or samples.

### BRIEF DESCRIPTION OF THE DRAWINGS

A number of non-limiting embodiments of the present invention will be described by way of example with reference to the accompanying drawings, in which:

FIG. 1 shows a simplified, schematic view of a luminescence analysis apparatus, in particular a fluorescence microscope, in accordance with the invention;

FIG. 2 shows a schematic, larger-scale, partly sectioned view of a detail of the FIG. 1 apparatus;

FIG. 3 shows a quality graph illustrating the emission curve of a LED and the absorption curve of an excitation filter, both forming part of the FIG. 1 apparatus;

FIG. 4 shows a simplified, partly sectioned, schematic view of a further embodiment of the apparatus according to the invention;

FIGS. 5 and 6 show partial schematic views, with parts removed for clarity, of respective details of the FIG. 4 apparatus.

### BEST MODE FOR CARRYING OUT THE INVENTION

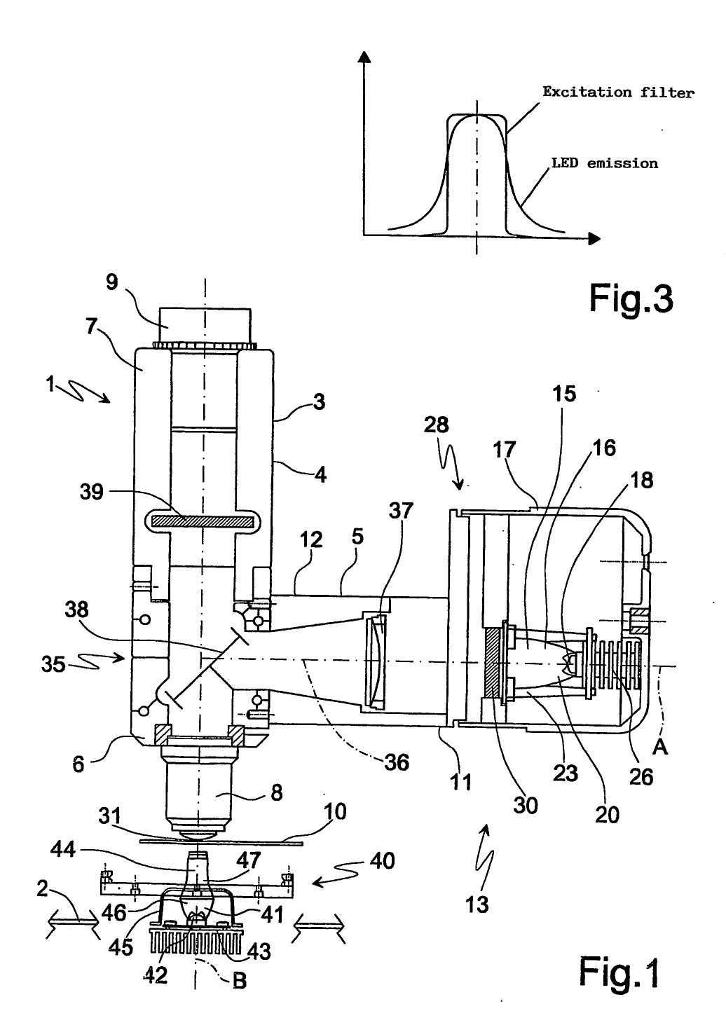

Number 1 in FIG. 1 indicates as a whole a luminescence analysis apparatus. In the example shown, apparatus 1 is an apparatus for fluorescence microscopy, i.e. an incident-light fluorescence microscope hereinafter referred to, for the sake of simplicity, as microscope 1.

Microscope 1 comprises a base structure 2, shown only schematically in FIG. 1, which in turn comprises casing 3 having a tubular main body 4, from which projects a tubular lateral body 5. Two axially opposite ends 6, 7 of main body 4 are fitted respectively with an objective 8 and an eyepiece 9, both of which are substantially known; and a known sample support 10 is located opposite objective 8.

A free end 11 of lateral body 5, opposite an end 12 attached to main body 4, is fitted with a lighting assembly 13, which comprises a lighting unit 15 having a preassembled module 16 housed inside a housing 17.

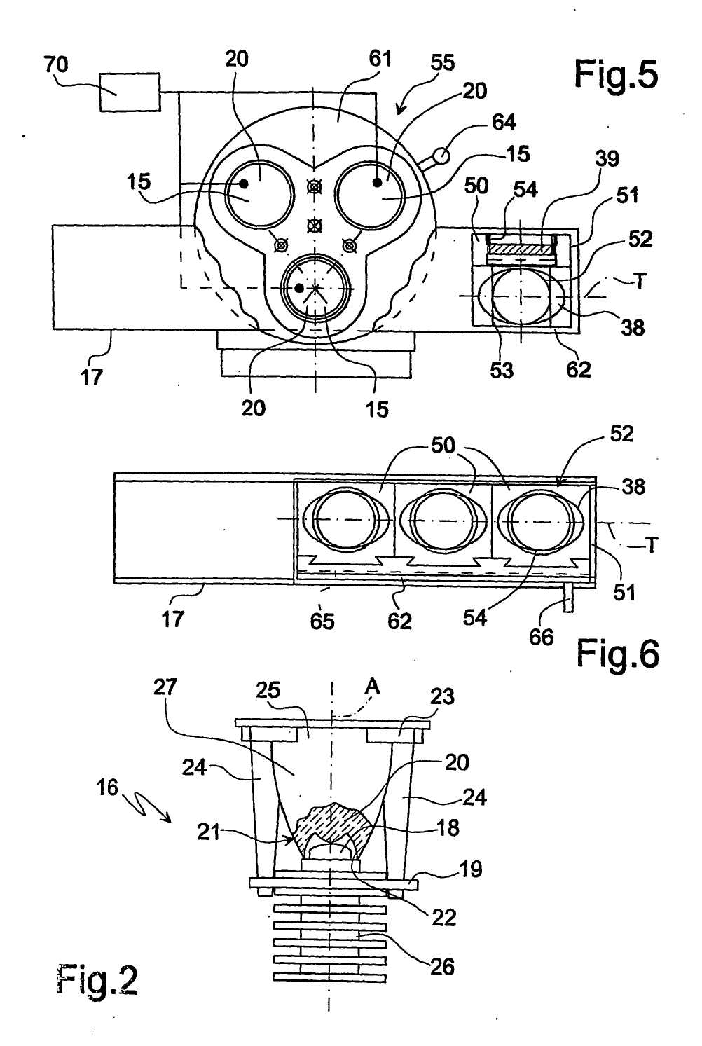

As shown in more detail in FIG. 2, module 16 comprises a LED (light-emitting diode or similar solid-state light source) 18 mounted on a plate 19; and an optical collimating element 20 fitted integrally and in close proximity to LED 18.

Optical element 20 is a complex-surface catadioptric collimator made of transparent plastic material (e.g. polycarbonate PC or polymethyl methacrylate PMMA), is substantially cup-shaped, extends along a central axis A of symmetry, and is bounded by a surface 21 of revolution constituting an internal reflection surface of optical element 20. LED 18 is housed inside a recess 22 formed at one axial end of optical element 20; and optical element 20 is designed to internally convey and transmit the light emitted by LED 18, so as to generate a substantially parallel beam of light rays.

Optical element 20 is supported to project from plate 19 by means of a supporting structure 23, which comprises a number of rods 24 projecting, substantially parallel to axis A, from a peripheral edge 25 of optical element 20. Rods 24 are spaced circumferentially apart along peripheral edge 25 to ensure effective ventilation of LED 18, and are fitted integrally in any known manner to plate 19 which, in turn, is fixed to a known dissipator 26 connected integrally to a wall of housing 17. Surface 21 is covered by a shell 27 formed, for example, in one piece with supporting structure 23.

The electric connections of LED 18 to a power source (external mains or a battery on base structure 2) are not shown for the sake of simplicity.

Housing 17 has means 28 for connection to base structure 2, and specifically to casing 3, and which, though shown only schematically in FIG. 1 as joints for the sake of simplicity, may be of any known type. Preferably, means 28 are releasable to open housing 17 (i.e. for access to module 16) or to remove housing 17 completely from casing 3.

Lighting unit 15 also comprises an excitation filter 30 housed inside housing 17 and located opposite optical element 20, on the opposite side to LED 18. Excitation filter 30 is interposed between optical element 20 and support 10 to select a given band for transmission to a luminescent (in particular, fluorescent) sample 31 on support 10. More specifically, excitation filter 30 is a band-pass filter which permits the passage of light of a wavelength in a predetermined band. As shown only qualitatively in the FIG. 3 graph (which shows wavelength along the x axis and transmission quality along the y axis), said band is superimposed on the emission band of LED 18 and located about a peak of the emission curve of LED 18.

Casing 3 houses optical means, indicated as a whole by 35, for defining an optical path 36 between lighting unit 15 and support 10, and which direct the light beam, generated by lighting unit 15, onto sample 31 in the same way as in conventional fluorescent microscopes. More specifically, optical means 35 comprise a lens 37 facing lighting unit 15 and located downstream from excitation filter 30 along optical path 36; and a dichroic plate 38 interposed between lens 37 and objective 8 and tilted with respect to axis A. An emission filter 39 is located between dichroic plate 38 and eyepiece 9 to filter the light emitted by sample 31 before it reaches eyepiece 9 (or any other known device for collecting emission by sample 31).

Beneath support 10, i.e. on the opposite side of support 10 to dichroic plate 38, an optional secondary lighting unit 40 may be provided for direct optical observation of sample 31 in transmitted or diffused light. Lighting unit 40 comprises a preassembled module 41, in turn comprising a LED 42 mounted on a plate 43; and a total internal reflection condenser 44 supported to project from plate 43 by a supporting structure 45, and fitted integrally and in close proximity to LED 42.

Condenser 44 is designed to internally convey and transmit the light emitted by LED 42, so as to generate a converging beam of light rays concentrated on sample 31. More specifically, condenser 44 has a body of revolution made of transparent plastic material, extends longitudinally along a central axis B of symmetry, and, at opposite axial ends, comprises a bulb-shaped portion 46 with a convex lateral surface and a recess for housing LED 42; and a substantially cylindrical portion 47.

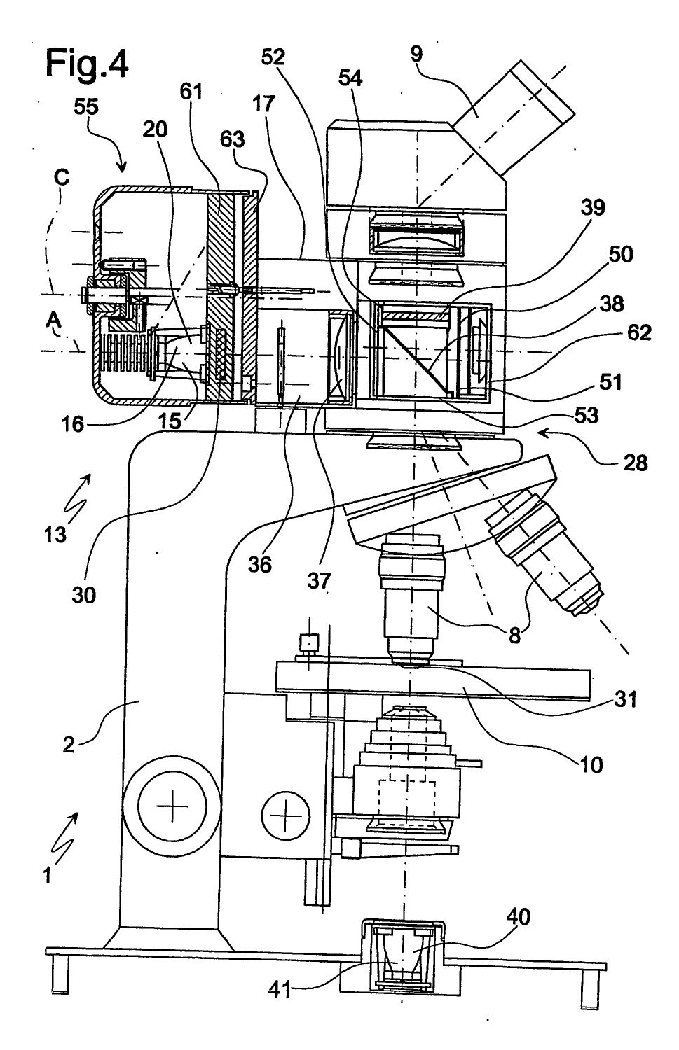

Alternatively (as shown in the FIG. 4 example), lighting unit 40 comprises a module 41 identical with module 16 described previously.

In actual use, the light emitted by LED 18 is conveyed highly efficiently in a parallel beam of light rays from optical element 20, and through excitation filter 30. By virtue of LED 18 emitting in a band which is in itself narrow and largely superimposed on the band allowed through by excitation filter 30, the percentage of light transmitted through excitation 30 is very high (roughly about 70%). The filtered light rays are then reflected by dichroic plate 38 through objective 8 onto sample 31, which fluoresces and emits light which travels through objective 8, dichroic plate 38, and emission filter 39 to eyepiece 9 where it is observed.

Two or more interchangeable integrated lighting units 15 of the type described above may advantageously be provided, comprising respective housings 17 housing respective preassembled modules 16 and respective excitation filters 30. Modules 16 comprise respective LEDs 18 having respective different emission bands; and respective optical collimating elements 20 connected integrally to LEDs 18 and shaped to direct respective substantially parallel beams of light rays onto optical means 35. Housings 17 of respective integrated lighting units 15 have respective releasable means 28 for attachment to base structure 2, so that each lighting unit 15 can be removed from base structure 2 and replaced with a different lighting unit 15. Alternatively, provision may be made for only changing modules 16 inside a single housing 17.

In the preferred embodiment shown in FIGS. 4 to 6, in which details similar to or identical with those already described are indicated using the same reference numbers, microscope 1 is equipped with a lighting assembly 13 comprising a housing 17 having releasable means 28 for attachment to base structure 2; at least one lighting unit 15; and at least one preassembled optical unit 50 associated with lighting unit 15 and housed, downstream from lighting unit 15, inside housing 17.

Lighting unit 15 is of the type described above. Optical unit 50 comprises a hollow, prismatic (e.g. substantially cubic) supporting body 51; a dichroic plate 38 housed inside supporting body 51, substantially facing optical element 20, and tilted with respect to the beam from optical element 20; and an emission filter 39 fitted to supporting body 51. Supporting body 51 has an entrance opening 52 and two opposite exit openings 53, 54, which are arranged in a T and formed in respective perpendicular faces of supporting body 51. In actual use, entrance opening 52 faces lighting unit 15, and exit openings 53, 54 face objective 8 (i.e. sample 31) and eyepiece 9 respectively. Dichroic plate 38 is interposed between entrance opening 52 and exit openings 53, 54, and is tilted with respect to the faces of supporting body 51 in which entrance opening 52 and exit openings 53, 54 are formed. Dichroic plate 38 is designed and located so that the light coming from lighting unit 15 through entrance opening 52 is diverted to exit opening 53, while the light from exit opening 53 travels through dichroic plate 38 to exit opening 54. Emission filter 39 is associated with and substantially closes exit opening 53.

In the example shown, lighting assembly 13 comprises a number of (in particular, three) interchangeable lighting units 15; a number of (in particular, three) interchangeable optical units 50; and selecting means 55 for selectively associating a lighting unit 15 with an optical unit 50.

Selecting means 55 may be of any substantially known type, and are therefore not shown or described in detail for the sake of simplicity. Generally speaking, selecting means 55 comprise a structure 61 supporting lighting units 15; and a 'structure 62 supporting optical units 50; and structures 61 and 62 are movable with respect to housing 17 to selectively position an optical unit 50 and a lighting unit 15 facing each other.

More specifically, structure 61 is a carousel structure, on which the three lighting units 15 are arranged with respective modules 16 parallel and spaced 120° apart about a central axis C, is fitted, so as to rotate about axis C, to a plate 63 fixed (in known manner) to base structure 2, and is movable manually, e.g. by means of a lever 64.

Structure 62 is a slide running along a slide axis T perpendicular to axis C, supports optical units 50 side by side, is mounted to run along guides 65 fixed to housing 17, and is movable manually, e.g. by means of a lever 66.

Lighting units 15 comprise respective LEDs 18 having respective different emission bands (e.g. three LEDs emitting red, green, and blue light respectively); and known control means 70 (shown only schematically in FIG. 5) are provided to selectively activate lighting units 15 as required.

The general structure described herein for a microscope 1 may obviously also be applied to a different type of fluorescence or luminescence analysis apparatus in general, e.g. for spectrophotometry, fluorometry, etc.

Clearly, the lighting assembly according to the invention may be installed on microscopes and commercial fluorescence analysis equipment in general, in lieu of conventional light sources, and may also be installed on conventional white- or transmitted-light microscopes, thus converting them, in fact, into fluorescence microscopes.

1. A lighting assembly (13) for a luminescence analysis apparatus (1), in particular a fluorescence microscope, comprising a housing (17) connectable to a base structure (2) of the apparatus (1) and housing at least one light source (18); the lighting assembly being characterized by comprising at least one integrated lighting unit (15), in turn comprising a LED (18) defining said light source, and an optical collimating element (20) associated with the LED (18) to convey the light generated by the LED (18) in a substantially parallel beam of light rays.

2. A lighting assembly as claimed in claim 1, characterized in that the lighting unit (15) comprises an excitation filter (30) located opposite the optical element (20), on the opposite side to the LED (18), to select a predetermined emission band of the LED (18).

3. A lighting assembly as claimed in claim 2, characterized in that said excitation filter (30) is a band-pass filter.

4. A lighting assembly as claimed in claim 3, characterized in that said excitation filter (30) permits the passage of light of a wavelength within a band superimposed on the emission band of the LED (18) and located about a peak of the LED emission curve.

5. A lighting assembly as claimed in claim 2, characterized by comprising an optical unit (50) associated with the lighting unit (15) and located downstream from the excitation filter (30) inside the housing (17); the optical unit (50) comprising a dichroic plate (38) substantially facing the optical element (20) and tilted with respect to the beam from the optical element (20).

6. A lighting assembly as claimed in claim 5, characterized in that the optical unit (50) comprises a hollow supporting body (51) having an entrance opening (52) and two opposite exit openings (53, 54); said dichroic plate (38) being housed in the supporting body (51) and interposed between the entrance opening (52) and the exit openings (53, 54).

7. A lighting assembly as claimed in claim 6, characterized in that the optical unit (50) comprises an emission filter (39) carried by said supporting body (51) and associated with a first exit opening (53).

8. A lighting assembly as claimed in claim 5, characterized by comprising two or more interchangeable lighting units (15) and/or two or more interchangeable optical units (50).

9. A lighting assembly as claimed in claim 8, characterized by comprising selecting means (55) for selectively associating a lighting unit (15) with an optical unit (50).

10. A lighting assembly as claimed in claim 9, characterized in that said selecting means (55) comprise a movable first structure (61) supporting the lighting units (15); and a movable second structure (62) supporting the optical units (50); said structures (61, 62) being movable with respect to the housing (17) to selectively position a lighting unit (15) and an optical unit (50) substantially facing each other.

11. A lighting assembly as claimed in claim 1, characterized in that the optical element (20) is located in close proximity to the LED (18), and is connected integrally to the LED (18) to define a preassembled module (16).

12. A lighting assembly as claimed in claim 1, characterized in that the optical element (20) is a complex-surface catadioptric collimator.

13. A lighting assembly as claimed in claim 1, characterized by comprising releasable means (28) for attaching the housing (17) to the base structure (2).

14. A luminescence analysis apparatus (1), in particular for fluorescence microscopy, characterized by comprising a lighting assembly (13) as claimed in claim 1.

15. An apparatus as claimed in claim 1, characterized by comprising a sample support (10), and optical means (35) for directing the light generated by the lighting assembly (13) onto a luminescent sample (31) on the support.
